(19) United States
(12) Patent Application Publication
(10) Pub. No.: US 2014/0004428 A1
(43) Pub. Date: Jan. 2, 2014

(54) IONIC LIQUID FOR AIR BATTERIES, LIQUID ELECTROLYTE FOR LITHIUM AIR BATTERIES COMPRISING THE IONIC LIQUID, AND AIR BATTERY

(71) Applicant: Hirofumi NAKAMOTO, Kyoto-shi (JP)

(72) Inventor: Hirofumi NAKAMOTO, Kyoto-shi (JP)

(73) Assignee: TOYOTA JIDOSHA KABUSHIKI KAISHA, Toyota-shi (JP)

(21) Appl. No.: 13/917,131

(22) Filed: Jun. 13, 2013

(30) Foreign Application Priority Data
Jul. 2, 2012 (JP) 2012-148255

(51) Int. Cl. H01M 6/16; H01M 12/06

(52) U.S. Cl. CPC H01M 6/162; H01M 12/06
USPC 429/403; 564/82

(57) ABSTRACT

An ionic liquid increases power density and discharge capacity in an air battery. Also, to provide a liquid electrolyte for lithium air batteries and an air battery, both of which include the ionic liquid. The ionic liquid for air batteries in which the cation has a structure represented by the following general formulae (1), (2) or (3):

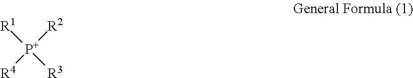

wherein R¹ to R⁴ are independent of each other, and R¹ to R⁴ are each an aliphatic hydrocarbon group having 1 to 8 carbon atoms, or the like;

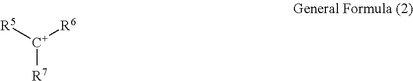

wherein R⁵ to R⁷ are independent of each other, and R⁵ to R⁷ are each an aliphatic hydrocarbon group having 1 to 8 carbon atoms, or the like;

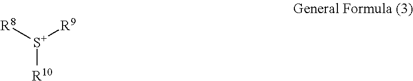

wherein R⁸ to R¹⁰ are independent of each other, and R⁸ to R¹⁰ are each an aliphatic hydrocarbon group having 1 to 8 carbon atoms, or the like.

### TECHNICAL FIELD

The present invention relates to an ionic liquid configured to increase power density and discharge capacity when used in an air battery. The present invention also relates to a liquid electrolyte for lithium air batteries and an air battery, each of which comprising the ionic liquid.

### BACKGROUND ART

An air battery is a rechargeable battery using a simple substance of metal or metal compound as the negative electrode active material and oxygen as the positive electrode active material. The positive electrode active material, oxygen, can be obtained from the air, so that it is not needed to encapsulate the positive electrode active material in the battery. In theory, therefore, the air battery can provide a larger capacity than a secondary battery using a solid positive electrode active material.

In the lithium-air battery, which is a kind of air battery, the reaction described by the following formula (1) proceeds at the negative electrode upon discharge:

2Li→2Li⁺+2e⁻ (I)

Electrons generated by the formula (1) pass through an external circuit, work by an external load, and then reach the air electrode. Lithium ions (Li⁺) generated by the formula (1) are transferred by electro-osmosis from the negative electrode side to the air electrode side through an electrolyte sandwiched between the negative electrode and the air electrode.

Upon discharge, the reactions described by the following formulae (II) and (III) proceed at the air electrode:

2Li⁺+O₂+2e⁻→Li₂O₂ (II)

2Li⁺+½O₂+2e⁻→Li₂O (III)

The thus-produced lithium peroxide (Li₂O₂) and lithium oxide (Li₂O) are stored in the air electrode in the form of solid.

Upon charging the battery, a reaction which is reverse to the reaction described by the formula (I) proceeds at the negative electrode, while reactions which are reverse to the reactions described by the formulae (II) and (III) proceed at the positive electrodes. Lithium metal is thus regenerated at the negative electrode. Because of this, discharge becomes possible again.

Since combustible, volatile organic solvents were used in the electrolytes of conventional lithium secondary batteries, there is a limit to increasing the safety of the batteries.

As an attempt to increase the safety, a lithium secondary battery comprising an ionic liquid (a room-temperature molten salt) as the liquid electrolyte, has been known. Here, the ionic liquid refers to a salt which is liquid at 100° C. or less, which is generally non-combustible and non-volatile. Such a non-combustible liquid electrolyte has such advantageous that it has a relatively wide potential window (potential range) and shows relatively high ion conductivity.

In Paragraph [0054] of the Specification of Patent Literature 1, a hydrophobic ionic liquid is mentioned as an example of a liquid electrolyte responsible for alkali metal ion conduction between the negative electrode layer and the air electrode layer of a metal-air battery.

An ionic liquid is disclosed in Patent Literature 2, which comprises, as a cation component, a phosphonium ion having one, two or four P—N bonds. In Paragraph [0001] of the Specification of Patent Literature 2, it is described to use the phosphonium ion-containing ionic liquid in a lithium secondary battery.

### CITATION LIST

Patent Literature 1: Japanese Patent Application Laid-Open No. 2011-003313
Patent Literature 2: International Publication No. 2007/063959

### SUMMARY OF INVENTION

### Technical Problem

In Paragraph [0057] of the Specification of Patent Literature 1, N,N-diethyl-N-methyl-N-(2-methoxyethyl)ammonium bis(trifluoromethanesulfonyl)amide, 1-ethyl-3-methylimidazolium bis(trifluoromethanesulfonyl)amide, and 1-butyl-3-methylimidazolium bis(trifluoromethanesulfonyl)amide, are mentioned as concrete examples of hydrophobic ionic liquids. However, as a result of diligent researches, the inventor of the present invention has found that air batteries comprising these ionic liquids are low in both power density and discharge capacity.

In Paragraphs, [0077], [0044] and [0132] of the Specification of Patent Literature 2, the following cyclic voltammetry are explained, respectively: cyclic voltammetry of an ionic liquid comprising a phosphonium cation having one P—N bond; cyclic voltammetry of an ionic liquid comprising a phosphonium cation having two P—N bonds; and cyclic voltammetry of an ionic liquid comprising a phosphonium cation having four P—N bonds. In FIGS. 1 to 3 of Patent Literature 2, cyclic voltammograms obtained by these cyclic voltammetry are shown. In Patent Literature 2, however, in addition to the cyclic voltammogram data, there are only mentioned basic physical data of a phosphonium ion-containing ionic liquid, such as NMR, melting point and electrical conductivity, and there is no description or suggestion on an air battery comprising the ionic liquid. Also in Patent Literature 2, there is no suggestion on concrete embodiments of the use of the phosphonium cation-containing ionic liquid in an air battery; moreover, there is no suggestion on the effects obtained by using the phosphonium cation-containing ionic liquid in an air battery, and also there is no description on the data which can support such effects.

The present invention was achieved in light of the above circumstances. An object of the present invention is to provide an ionic liquid configured to increase power density and discharge capacity when used in an air battery. Another object of the present invention is to provide a liquid electrolyte for lithium air batteries and an air battery, each of which comprising the ionic liquid.

### Solution to Problem

The ionic liquid for air batteries according to the present invention, comprises a cation and a counter anion thereof, wherein the cation has a structure represented by the following general formulae (1), (2) or (3):

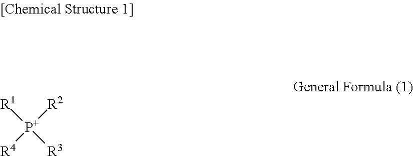

wherein R¹ to R⁴ are independent of each other, and R¹ to R⁴ are each selected from the group consisting of: an aliphatic hydrocarbon group having 1 to 8 carbon atoms; an aromatic hydrocarbon group having 6 to 10 carbon atoms; an amino group represented by —NR^{a}R^{b} in which R^{a} and R^{b} are groups independent of each other and R^{a} and R^{b} are each a hydrogen, an aliphatic hydrocarbon group having 1 to 8 carbon atoms or an aromatic hydrocarbon group having 6 to 10 carbon atoms; an alkoxy group represented by —OR^{c} in which R^{c} is an aliphatic hydrocarbon group having 1 to 8 carbon atoms; and an aryloxy group represented by —OR^{d} in which R^{d} is an aromatic hydrocarbon group having 6 to 10 carbon atoms;

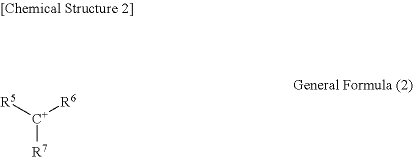

wherein R⁵ to R⁷ are independent of each other, and R⁵ to R⁷ are each selected from the group consisting of: an aliphatic hydrocarbon group having 1 to 8 carbon atoms; an aromatic hydrocarbon group having 6 to 10 carbon atoms; an amino group represented by —NR^{a}R^{b} in which R^{a} and R^{b} are groups independent of each other and R^{a} and R^{b} are each a hydrogen, an aliphatic hydrocarbon group having 1 to 8 carbon atoms or an aromatic hydrocarbon group having 6 to 10 carbon atoms; an alkoxy group represented by —OR^{c} in which R^{c} is an aliphatic hydrocarbon group having 1 to 8 carbon atoms; and an aryloxy group represented by —OR^{d} in which R^{d} is an aromatic hydrocarbon group having 6 to 10 carbon atoms; and

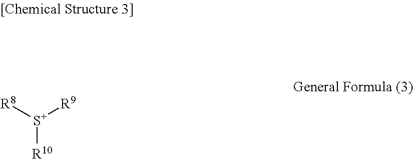

wherein R⁸ to R¹⁰ are independent of each other, and R⁸ to R¹⁰ are each selected from the group consisting of: an aliphatic hydrocarbon group having 1 to 8 carbon atoms; an aromatic hydrocarbon group having 6 to 10 carbon atoms; an amino group represented by —NR^{a}R^{b} in which R^{a} and R^{b} are groups independent of each other and R^{a} and R^{b} are each a hydrogen, an aliphatic hydrocarbon group having 1 to 8 carbon atoms or an aromatic hydrocarbon group having 6 to 10 carbon atoms; an alkoxy group represented by —OR^{c} in which R^{c} is an aliphatic hydrocarbon group having 1 to 8 carbon atoms; and an aryloxy group represented by —OR^{d} in which R^{d} is an aromatic hydrocarbon group having 6 to 10 carbon atoms.

In the present invention, at least one of R¹ to R⁴ in the general formula (1), at least one of R⁵ to R⁷ in the general formula (2), or at least one of R⁸ to R¹⁰ in the general formula (3) can be an amino group represented by —NR^{a}R^{b}, and R^{a} and R^{b} can be groups independent of each other and R^{a} and R^{b} can be each an aliphatic hydrocarbon group having 1 to 8 carbon atoms or an aromatic hydrocarbon group having 6 to 10 carbon atoms.

In the present invention, at least one of R¹ to R⁴ in the general formula (1), at least one of R⁵ to R⁷ in the general formula (2) or at least one of R⁸ to R¹⁰ in the general formula (3) can be an alkoxy group represented by —OR^{c} in which R^{c} is an aliphatic hydrocarbon group having 1 to 8 carbon atoms.

The liquid electrolyte for lithium air batteries according to the present invention, comprises a lithium salt and the above-described ionic liquid for air batteries.

The air battery of the present invention comprising an air electrode, a negative electrode and an electrolyte layer present between the air and negative electrodes, wherein the electrolyte layer comprises the above-described ionic liquid for air batteries.

### Advantageous Effects of Invention

When the ionic liquid of the present invention is used in an air battery, the liquid comprising a cation which has an atom having a lower electronegativity than that of nitrogen atoms, the cation is less likely to adhere to the air electrode, and more oxygen, which is used for electrode reaction, can be supplied to active sites on the air electrode surface; therefore, the power density and discharge capacity of the air battery can be increased higher than conventional air batteries comprising an ammonium cation-containing ionic liquid.

### BRIEF DESCRIPTION OF DRAWINGS

FIG. 1 shows an example of a layer structure of the air battery according to the present invention, which is a view schematically showing a section cut in the laminating direction.

FIG. 2 is a graph comparing the time dependencies of oxygen reduction current values of liquid electrolytes for lithium-air batteries of Examples 1 to 3 and Comparative Example 1.

FIG. 3 is a bar graph comparing the discharge capacities of lithium-air batteries of Examples 4 to 6 and Comparative Example 2.

FIG. 4 is a bar graph comparing the power densities of lithium-air batteries of Examples 4 to 6 and Comparative Example 2.

### DESCRIPTION OF EMBODIMENTS

### 1. Ionic Liquid for Air Batteries

The ionic liquid for air batteries according to the present invention, comprises a cation and a counter anion thereof, wherein the cation has a structure represented by the following general formulae (1), (2) or (3):

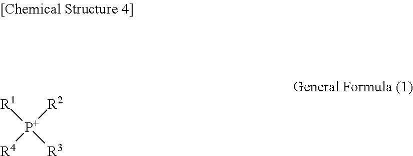

wherein R¹ to R⁴ are independent of each other, and R¹ to R⁴ are each selected from the group consisting of: an aliphatic hydrocarbon group having 1 to 8 carbon atoms; an aromatic hydrocarbon group having 6 to 10 carbon atoms; an amino group represented by —NR^{a}R^{b} in which R^{a} and R^{b} are groups independent of each other and R^{a} and R^{b} are each a hydrogen, an aliphatic hydrocarbon group having 1 to 8 carbon atoms or an aromatic hydrocarbon group having 6 to 10 carbon atoms; an alkoxy group represented by —OR^{c} in which R^{c} is an aliphatic hydrocarbon group having 1 to 8 carbon atoms; and an aryloxy group represented by —OR^{d} in which R^{d} is an aromatic hydrocarbon group having 6 to 10 carbon atoms;

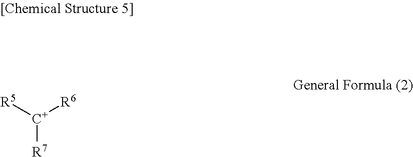

wherein R⁵ to R⁷ are independent of each other, and R⁵ to R⁷ are each selected from the group consisting of: an aliphatic hydrocarbon group having 1 to 8 carbon atoms; an aromatic hydrocarbon group having 6 to 10 carbon atoms; an amino group represented by —NR^{a}R^{b} in which R^{a} and R^{b} are groups independent of each other and R^{a} and R^{b} are each a hydrogen, an aliphatic hydrocarbon group having 1 to 8 carbon atoms or an aromatic hydrocarbon group having 6 to 10 carbon atoms; an alkoxy group represented by —OR^{c} in which R^{c} is an aliphatic hydrocarbon group having 1 to 8 carbon atoms; and an aryloxy group represented by —OR^{d} in which R^{d} is an aromatic hydrocarbon group having 6 to 10 carbon atoms; and

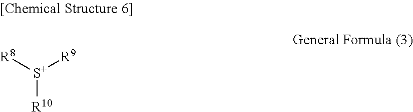

wherein R⁸ to R¹⁰ are independent of each other, and R⁸ to R¹⁰ are each selected from the group consisting of: an aliphatic hydrocarbon group having 1 to 8 carbon atoms; an aromatic hydrocarbon group having 6 to 10 carbon atoms; an amino group represented by —NR^{a}R^{b} in which R^{a} and R^{b} are groups independent of each other and R^{a} and R^{b} are each a hydrogen, an aliphatic hydrocarbon group having 1 to 8 carbon atoms or an aromatic hydrocarbon group having 6 to 10 carbon atoms; an alkoxy group represented by —OR^{c} in which R^{c} is an aliphatic hydrocarbon group having 1 to 8 carbon atoms; and an aryloxy group represented by —OR^{d} in which R^{d} is an aromatic hydrocarbon group having 6 to 10 carbon atoms.

As described above, conventional air batteries comprising an ionic liquid that contains an ammonium cation, like the one disclosed in Patent Literature 1, are low in power density and discharge capacity. As a result of diligent researches, the inventor of the present invention has found that the low power density and discharge capacity of conventional air batteries come from the chemical structure of the cation in the ionic liquid, especially from the type of the central atom(s) of the cation. In the Specification of the present invention, “central atom of cation” means an atom which is described to have a positive charge (+) in the structural formula of the cation. However, the central atom is just needed to be an atom which is described to have a positive charge, and the atom is not needed to actually have a positive charge. The number of the central atom(s) present per cation can be one or more.

The electronegativity of nitrogen, which will be the central atom of the ammonium cation in the present invention, is 3.04 (Pauling's electronegativity; hereinafter, for electronegativity values, see publicly known references (Chronological Scientific Tables, First Edition. Edited by National Astronomical Observatory of Japan. Published by Maruzen Publishing Co., Ltd. Nov. 30, 2007. P. 368)). Nitrogen is an element which has the fourth highest electronegativity among all elements, after fluorine (F, electronegativity 3.98), oxygen (O, electronegativity 3.44) and chlorine (Cl, electronegativity 3.16). Due to the high electronegativity, electrons are apt to locally gather around a nitrogen atom, so that a partial charge is likely to occur in the ammonium cation. When used in an air battery, such a partially charged cation is likely to adhere to an active site on the electrode surface. For example, upon discharge from the air battery, the partially charged cation is likely to adhere to an active site on the air electrode surface. Supply of ions and oxygen to the active site on the electrode surface, which will participate in electrode reaction, is blocked by the cations adhering to the active sites to prevent the electrode reaction from progressing; therefore, there is a partial loss in electrode performance and thus a decrease in power density and discharge capacity of the air battery.

As a result of diligent researches, the inventor of the present invention has found that the cation having the structures represented by the general formulae (1), (2) and (3) has a uniform charge distribution as a whole, so that the cation is less likely to adhere to electrode surface and, as a result, when the ionic liquid comprising the cation is used in an air battery, the air battery is provided with a higher power density and discharge capacity than conventional air batteries comprising an ammonium cation-containing ionic liquid. Then, the inventor accomplished the present invention based on the findings.

The central atoms of the cations represented by the general formulae (1) to (3) are phosphorus (P, electronegativity 2.19), carbon (C, electronegativity 2.55) and sulfur (S, electronegativity 2.58), respectively. These electronegativity values are lower than the electronegativity value of nitrogen. Therefore, a partial charge is less likely to occur in the cations represented by the general formulae (1) to (3), than the above-described ammonium cation, so that the cations represented by the general formulae (1) to (3) have uniform charge distribution. Because of this, when the ionic liquids comprising the cations represented by the general formulae (1) to (3) are used in an air battery, the cation is less likely to adhere to an active site on electrode surface than conventional air batteries comprising an ammonium cation-containing ionic liquid, and a large, active electrode area can be obtained. As a result, it is possible to supply a large amount of lithium ions and oxygen, which will participate in electrode reaction, to electrode and thus to increase the power density and discharge capacity of the air battery.

In the chronoamperometry which will be explained under “Examples” below, it was observed that the oxygen reduction current value of the ionic liquid of the present invention (Examples 1 to 3) was twice or more the oxygen reduction current value of the ionic liquid used in conventional air batteries (Comparative Example 1). From this result, the inventor of the present invention has found that the ability of the ionic liquid of the present invention to diffuse oxygen in electrolyte of an air battery, is better than that of conventional, ammonium cation-containing ionic liquids.

Meanwhile, as is clear from the results of the electrical conductivity measurement which will be explained under “Examples,” the electrical conductivity of the ionic liquid of the present invention is nearly equal to or less than the electrical conductivity of conventional, ammonium cation-containing ionic liquids. When considered in light of both the results of the chronoamperometry and the results of discharge and I-V tests for air battery, which will be explained below under “Examples,” it can be said that the ion supply ability of the ionic liquid of the present invention contributes to an improvement in air battery performance, but not as much as the oxygen supply ability thereof. That is, it can be said that due to its excellent oxygen supply ability, the ionic liquid of the present invention is an ionic liquid which is specialized for use in air batteries.

In the general formula (1), R¹ to R⁴, each of which has a bond with a phosphorus atom, are not particularly limited as long as they are independent of each other and are each any one of an aliphatic hydrocarbon group having 1 to 8 carbon atoms, an aromatic hydrocarbon group having 6 to 10 carbon atoms, an amino group, an alkoxy group and an aryloxy group.

As the aliphatic hydrocarbon group having 1 to 8 carbon atoms and a bond with a phosphorus atom, for example, there may be mentioned a methyl group (—CH₃), ethyl group (—C₂H₅), n-propyl group (—CH₂—CH₂—CH₃), i-propyl group (—CH(CH₃)₂), n-butyl group (—CH₂—CH₂—CH₂—CH₃), i-butyl group (—CH₂—CH(CH₃)₂), sec-butyl group (—CH(CH₃)—CH₂—CH₃), t-butyl group (—C(CH₃)₃), n-pentyl group (—CH₂—CH₂—CH₂—CH₂—CH₃), i-pentyl group (—CH₂—CH₂—CH(CH₃)₂), neopentyl group (—CH₂—C(CH₃)₂—CH₃), n-hexyl group (—CH₂—CH₂—CH₂—CH₂—CH₂—CH₃), i-hexyl group (—CH₂—CH₂—CH₂—CH(CH₃)₂), n-heptyl group (—CH₂—CH₂—CH₂—CH₂—CH₂—CH₂—CH₃), i-heptyl group (—CH₂—CH₂—CH₂—CH₂—CH(CH₃)₂), n-octyl group (—CH₂—CH₂—CH₂—CH₂—CH₂—CH₂—CH₂—CH₃) and i-octyl group (—CH₂—CH₂—CH₂—CH₂—CH₂—CH(CH₃)₂). Among them, preferred is an aliphatic hydrocarbon having 1 to 5 carbon atoms, and more preferred are a methyl group, ethyl group, n-propyl group, i-propyl group, n-butyl group and n-pentyl group.

As the aromatic hydrocarbon group having 6 to 10 carbon atoms having an bond with a phosphorus atom, for example, there may be mentioned a phenyl group (—C₆H₅), o-toluoyl group (—C₆H₄(CH₃)), m-toluoyl group, p-toluoyl group, 2,4-xylyl group (—C₆H₃(CH₃)₂), 2,6-xylyl group, 2,4,6-trimethylphenyl group (—C₆H₂(CH₃)₃), 1-naphthyl group (—C₁₀H₇) and 2-naphthyl group. Among them, more preferred are a phenyl group, 1-naphthyl group and 2-naphthyl group.

The amino group (—NR^{a}R^{b}) having an bond with a phosphorus atom is not particularly limited as long as R^{a} and R^{b} are independent of each other and are each any one of a hydrogen, an aliphatic hydrocarbon group having 1 to 8 carbon atoms and an aromatic hydrocarbon group having 6 to 10 carbon atoms. The aliphatic hydrocarbon group having 1 to 8 carbon atoms which is used as R^{a} and R^{b} is the same as the aliphatic hydrocarbon group having 1 to 8 carbon atoms and a bond with a phosphorus atom. The aromatic hydrocarbon group having 6 to 10 carbon atoms which is used as R^{a} and R^{b} is the same as the aromatic hydrocarbon group having 6 to 10 carbon atoms and a bond with a phosphorus atom.

As the amino group (—NR^{a}R^{b}) having an bond with a phosphorus atom, for example, there may be mentioned an amino group (—NH₂), methylamino group (—NHCH₃), dimethylamino group (—N(CH₃)), ethylamino group (—NHC₂Hs), ethylmethylamino group (—N(CH₃)—C₂H₅), diethylamino group (—N(C₂H₅)₂), n-propylamino group (—NH—CH₂—CH₂—CH₃), methyl n-propylamino group (—N(CH₃)—CH₂—CH₂—CH₃), n-butylamino group (—NH—CH₂—CH₂—CH₂—CH₃), n-butylmethylamino group (—N(CH₃)—CH₂—CH₂—CH₂—CH₃), n-pentylamino group (—NH—CH₂—CH₂—CH₂—CH₂—CH₃), methyl n-pentylamino group (—N(CH₃)—CH₂—CH₂—CH₂—CH₂—CH₃), n-hexylamino group (—NH—CH₂—CH₂—CH₂—CH₂—CH₂—CH₃), n-hexylmethylamino group (—N(CH₃)—CH₂—CH₂—CH₂—CH₂—CH₂—CH₃), n-heptylamino group (—NH—CH₂—CH₂—CH₂—CH₂—CH₂—CH₂—CH₃), n-heptylmethylamino group (—N(CH₃)—CH₂—CH₂—CH₂—CH₂—CH₂—CH₂—CH₃), n-octylamino group (—NH—CH₂—CH₂—CH₂—CH₂—CH₂—CH₂—CH₂—CH₃) and methyl n-octylamino group (—N(CH₃)—CH₂—CH₂—CH₂—CH₂—CH₂—CH₂—CH₂—CH₃).

The amino group (—NR^{a}R^{b}) having an bond with a phosphorus atom can be a tertiary amino group, that is, an amino group in which R^{a} and R^{b} are independent of each other and are each an aliphatic hydrocarbon group having 1 to 8 carbon atoms or an aromatic hydrocarbon group having 6 to 10 carbon atoms. A tertiary amino group has high electron-donating ability, so that electrons are more likely to be supplied to the phosphorus atom and, as a result, a more uniform charge distribution is provided to the cation. Concrete examples of tertiary amino groups include a dimethylamino group, ethylmethylamino group, diethylamino group, methyl n-propylamino group, n-butylmethylamino group, methyl n-pentylamino group, n-hexylmethylamino group, n-heptylmethylamino group and methyl n-octylamino group.

The alkoxy group (—OR^{c}) having a bond with a phosphorus atom is not particularly limited as long as R^{c} is an aliphatic hydrocarbon group having 1 to 8 carbon atoms. The aliphatic hydrocarbon group having 1 to 8 carbon atoms which can be used as R^{c} is the same as the aliphatic hydrocarbon group having 1 to 8 carbon atoms and a bond with a phosphorus atom.

As the alkoxy group (—OR^{c}) having a bond with a phosphorus atom, for example, there may be mentioned a methoxy group (—OCH₃), ethoxy group (—OC₂H₅), n-propoxy group (—OCH₂—CH₂—CH₃), i-propoxy group (—OCH(CH₃)₂), n-butoxy group (—OCH₂—CH₂—CH₂—CH₃), i-butoxy group (—OCH₂—CH(CH₃)₂), sec-butoxy group (—OCH(CH₃)—CH₂—CH₃), t-butoxy group (—OC(CH₃)₃), n-pentyloxy group (—OCH₂—CH₂—CH₂—CH₂—CH₃), i-pentyloxy group (—OCH₂—CH₂—CH(CH₃)₂), n-hexyloxy group (—OCH₂—CH₂—CH₂—CH₂—CH₂—CH₃), i-hexyloxy group (—OCH₂—CH₂—CH₂—CH(CH₃)₂), n-heptyloxy group (—OCH₂—CH₂—CH₂—CH₂—CH₂—CH₂—CH₃), i-heptyloxy group (—OCH₂—CH₂—CH₂—CH₂—CH(CH₃)₂), n-octyloxy group (—OCH₂—CH₂—CH₂—CH₂—CH₂—CH₂—CH₂—CH₃) and i-octyloxy group (—OCH₂—CH₂—CH₂—CH₂—CH₂—CH(CH₃)₂). Among them, preferred is an alkoxy group containing an aliphatic hydrocarbon group having 1 to 5 carbon atoms, and more preferred are a methoxy group, ethoxy group, n-propoxy group, i-propoxy group, n-butoxy group and n-pentyloxy group.

The aryloxy group (—OR^{d}) having a bond with a phosphorus atom is not particularly limited as long as R^{d} is an aromatic hydrocarbon group having 6 to 10 carbon atoms. The aromatic hydrocarbon group having 6 to 10 carbon atoms which can be used as R^{d} is the same as the aromatic hydrocarbon group having 6 to 10 carbon atoms and a bond with a phosphorus atom.

As the aryloxy group (—OR^{d}) having a bond with a phosphorus atom, for example, there may be mentioned a phenoxy group (—OC₆H₅), o-toluoyloxy group (—OC₆H₄(CH₃)), m-toluoyloxy group, p-toluoyloxy group, 2,4-xylyloxy group (—OC₆H₃(CH₃)₂), 2,6-xylyloxy group, 2,4,6-trimethylphenyloxy group (—OC₆H₂(CH₃)₃), 1-naphthyloxy group (—OC₁₀H₇) and 2-naphthyloxy group. Among them, more preferred are a phenoxy group, 1-naphthyloxy group and 2-naphthyloxy group.

In the general formula (1), R¹ to R⁴, each of which has a bond with a phosphorus atom, can be any one of the following, above-mentioned groups, each of which contains a sulfur atom (S) and/or phosphorus atom (P): the aliphatic hydrocarbon group having 1 to 8 carbon atoms, the aromatic hydrocarbon group having 6 to 10 carbon atoms, the amino group, the alkoxy group and the aryloxy group.

To produce the cation having the structure represented by the general formula (1), publicly known synthesis methods can be used. For example, there may be used production methods disclosed in publicly known references such as Patent Literature 2 (International Publication No. 2007/063959) and International Publication No. 2008/153045.

In the general formula (2), R⁵ to R⁷, each of which has a bond with a carbon atom, is not particularly limited as long as they are independent of each other and are each any one of an aliphatic hydrocarbon group having 1 to 8 carbon atoms, an aromatic hydrocarbon group having 6 to 10 carbon atoms, an amino group, an alkoxy group and an aryloxy group.

As the aliphatic hydrocarbon group having 1 to 8 carbon atoms having a bond with a carbon atom, there may be mentioned those that are the same as the examples of the aliphatic hydrocarbon group having 1 to 8 carbon atoms having a bond with a phosphorus atom. As the aromatic hydrocarbon group having 6 to 10 carbon atoms having a bond with a carbon atom, there may be mentioned those that are the same as the examples of the aromatic hydrocarbon group having 6 to 10 carbon atoms having a bond with a phosphorus atom. As the amino group (—NR^{a}R^{b}) having a bond with a carbon atom, there may be mentioned those that are the same as the examples of the amino group (—NR^{a}R^{b}) having a bond with a phosphorus atom. As the alkoxy group (—OR^{c}) having a bond with a carbon atom, there may be mentioned those that are the same as the examples of the alkoxy group (—OR^{c}) having a bond with a phosphorus atom. As the aryloxy group (—OR^{d}) having a bond with a carbon atom, there may be mentioned those that are the same as the examples of the aryloxy group (—OR^{d}) having a bond with a phosphorus atom.

In the general formula (2), R⁵ to R⁷, each of which has a bond with a carbon atom, can be any one of the following, above-mentioned groups, each of which contains a sulfur atom (S) and/or phosphorus atom (P): the aliphatic hydrocarbon group having 1 to 8 carbon atoms, the aromatic hydrocarbon group having 6 to 10 carbon atoms, the amino group, the alkoxy group and the aryloxy group.

To produce the cation having the structure represented by the general formula (2), publicly known synthesis methods can be used. For example, there may be used production methods disclosed in publicly known references such as Japanese Patent Application Laid-Open (JP-A) No. 2005-203363.

In the general formula (3), R⁸ to R¹⁰, each of which has a bond with a sulfur atom, is not particularly limited as long as they are independent of each other and are each any one of an aliphatic hydrocarbon group having 1 to 8 carbon atoms, an aromatic hydrocarbon group having 6 to 10 carbon atoms, an amino group, an alkoxy group and an aryloxy group.

As the aliphatic hydrocarbon group having 1 to 8 carbon atoms having a bond with a sulfur atom, there may be mentioned those that are the same as the examples of the aliphatic hydrocarbon group having 1 to 8 carbon atoms having a bond with a phosphorus atom. As the aromatic hydrocarbon group having 6 to 10 carbon atoms having a bond with a sulfur atom, there may be mentioned those that are the same as the examples of the aromatic hydrocarbon group having 6 to 10 carbon atoms having a bond with a phosphorus atom. As the amino group (—NR^{a}R^{b}) having a bond with a sulfur atom, there may be mentioned those that are the same as the examples of the amino group (—NR^{a}R^{b}) having a bond with a phosphorus atom. As the alkoxy group (—OR^{c}) having a bond with a sulfur atom, there may be mentioned those that are the same as the examples of the alkoxy group (—OR^{c}) having a bond with a phosphorus atom. As the aryloxy group (—OR^{d}) having a bond with a sulfur atom, there may be mentioned those that are the same as the examples of the aryloxy group (—OR^{d}) having a bond with a phosphorus atom.

In the general formula (3), R⁸ to R¹⁰, each of which has a bond with a sulfur atom, can be any one of the following, above-mentioned groups, each of which contains a sulfur atom (S) and/or phosphorus atom (P): the aliphatic hydrocarbon group having 1 to 8 carbon atoms, the aromatic hydrocarbon group having 6 to 10 carbon atoms, the amino group, the alkoxy group and the aryloxy group.

To produce the cation having the structure represented by the general formula (3), publicly known synthesis methods can be used. For example, there may be used production methods disclosed in publicly known references such as JP-A No. 2008-231033.

The counter anion used in the present invention is not particularly limited as long as the anion is inactive on the metals which functions as the ion sources of an air battery (for example, in the case of a lithium-air battery, lithium metal). The examples include those that are generally used as the anion species of ionic liquids.

Here, the anion which is inactive on the metal means a stable anion which shows no change in its chemical structure even if the metal is immersed for 100 minutes in an ionic liquid containing the anion. On the other hand, the anion which is active on the metal means an anion which is decomposed by immersion of the metal for 100 minutes in an ionic liquid containing the anion.

Concrete examples of the counter anion used in the present invention include amide anions such as [N(CF₃)₂]⁻, [N(SO₂CF₃)₂]⁻ and [N(SO₂C₂F₅)₂]⁻; sulfate anions or sulfite anions such as RSO₃⁻ (hereinafter, R means an aliphatic or aromatic hydrocarbon group), RSO₄⁻, R^{f}SO₃⁻ (hereinafter, R^{f} means a fluorine-containing halogenated hydrocarbon group) and R^{f}SO₄⁻; phosphate anions such as R^{f}₂P(O)O⁻ and R^{f}₃PF₃⁻; and other anions such as a lactate anion and a trifluoroacetate anion.

Of these anions, the counter anion used in the present invention is preferably bis(trifluoromethanesulfonyl)amide anion ([N(SO₂CF₃)₂]⁻).

Of anions represented by the above-described general formulae (1) to (3), a phosphonium cation represented by the general formula (1) is preferably used in the present invention.

Concrete examples of the ionic liquid for air batteries according to the present invention include triethylpentylphosphonium bis(trifluoromethanesulfonyl)amide, tris(dimethylamino)-n-butoxyphosphonium bis(trifluoromethanesulfonyl)amide, ethyltri(butylmethylamino)phosphonium bis(trifluoromethanesulfonyl)amide, triethylhexylphosphonium bis(trifluoromethanesulfonyl)amide, trimethylpropylphosphonium bis(trifluoromethanesulfonyl)amide, triethylpentylphosphonium trifluoromethanesulfonate, triethyl-3-methylbutylphosphonium bis(trifluoromethanesulfonyl)amide, and triethyl-2-ethylbutylphosphonium bis(trifluoromethanesulfonyl)amide.

The ionic liquid of the present invention can be used in a sodium air battery when the liquid contains sodium salt. Also, the ionic liquid can be used in a potassium-air battery when the liquid contains potassium salt. Similarly, the ionic liquid for air batteries can be also used in magnesium- and calcium-air batteries, etc.

The applications of the ionic liquid of the present invention are not particularly limited as long as they are air battery material applications. For example, the ionic liquid of the present invention can be used in an electrolyte layer which exchanges ions between electrodes. Also, the ionic liquid can be used as an electrolyte for electrodes, which is configured to increase ion conductivity of the inside of electrodes.

### 2. Liquid Electrolyte for Lithium-Air Batteries

The liquid electrolyte for lithium air batteries according to the present invention, comprises a lithium salt and the above-described ionic liquid for air batteries.

In addition to the above-described ionic liquid, the liquid electrolyte of the present invention comprises the lithium salt as a supporting salt. As the lithium salt, for example, there may be mentioned inorganic lithium salts such as LiOH, LiPF₆, LiBF₄, LiClO₄ and LiAsF₆, and organic lithium salts such as LiCF₃SO₃, LiN(SO₂CF₃)₂(LiTFSA), LiN(SO₂C₂F₅)₂ and LiC(SO₂CF₃)₃. These lithium salts can be used alone or in combination of two or more kinds.

Preferably, the liquid electrolyte for lithium-air batteries has a lithium salt concentration of 0.10 to 2.4 mol/kg. When the lithium salt concentration is less than 0.10 mol/kg, the lithium ion amount is too small and may result in poor lithium ion transport performance. On the other hand, when the lithium salt concentration exceeds 2.4 mol/kg, which is too high, the liquid electrolyte viscosity becomes too high and may result in poor lithium ion transport performance.

The lithium salt concentration of the liquid electrolyte is more preferably 0.32 mol/kg or more, still more preferably 0.50 mol/kg or more. Also, the lithium salt concentration of the liquid electrolyte is more preferably 1.4 mol/kg or less, still more preferably 1.2 mol/kg or less.

In addition to the ionic liquid for air batteries and the lithium salt, the liquid electrolyte for lithium-air batteries according to the present invention can further comprise a non-aqueous electrolyte.

As the non-aqueous electrolyte, non-aqueous liquid electrolytes and non-aqueous gel electrolytes can be used.

In general, the non-aqueous liquid electrolyte comprises the above-described lithium salt and a non-aqueous solvent. As the non-aqueous solvent, for example, there may be mentioned ethylene carbonate (EC), propylene carbonate (PC), dimethyl carbonate (DMC), diethyl carbonate (DEC), ethyl methyl carbonate (EMC), ethyl carbonate, butylene carbonate, γ-butyrolactone, sulfolane, acetonitrile, 1,2-dimethoxyethane, 1,3-dimethoxypropane, diethyl ether, tetrahydrofuran, 2-methyltetrahydrofuran, and mixtures thereof. The non-aqueous solvent is preferably a solvent with high oxygen solubility, from the viewpoint of efficient utilization of dissolved oxygen for reaction. In the non-aqueous liquid electrolyte, the lithium salt concentration is in the range of 0.5 to 3 mol/L, for example.

The non-aqueous gel electrolyte used in the present invention is normally a gelled non-aqueous electrolyte produced by adding a polymer to a non-aqueous liquid electrolyte. For example, it can be obtained by adding a polymer such as polyethylene oxide (PEO), polyacrylonitrile (PAN) and polymethyl methacrylate (PMMA) to the above-mentioned non-aqueous liquid electrolyte to gel. In the present invention, an LiTFSA(LiN(CF₃SO₂)₂)-PEO-based non-aqueous gel electrolyte can be used.

### 3. Air Battery

The air battery of the present invention comprises an air electrode, a negative electrode and an electrolyte layer present between the air and negative electrodes, wherein the electrolyte layer comprises the above-described ionic liquid for air batteries.

As explained above, in the cation in the ionic liquid for air batteries of the present invention, the electronegativity of the central atom of the cation is lower than the electronegativity of nitrogen. Since the central atom of the cation becomes less likely to be electrically charged, the charge distribution of the whole cation is more uniform than conventional ionic liquids. As a result, the cation is less likely to adhere to the air electrode. In the air battery of the present invention, therefore, lithium ions and oxygens diffused in the electrolyte layer are not blocked by the ionic liquid in the electrolyte layer and are likely to be supplied to the air electrode, resulting in high power density and high discharge capacity of the air electrode. As shown in examples below, compared to a conventional air battery comprising an ammonium cation-containing ionic liquid (Comparative Example 2), the air battery of the present invention (Examples 4 to 6) has about twice the power density of and twice the discharge capacity of the conventional air battery.

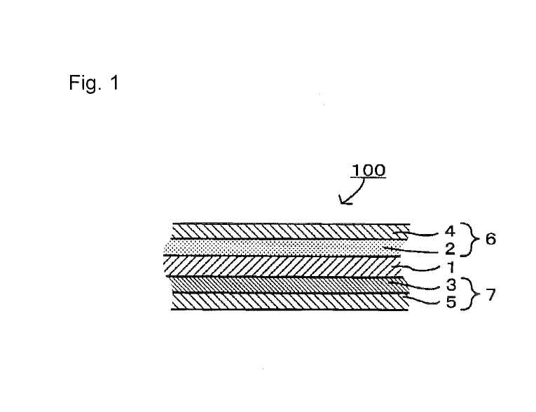

FIG. 1 shows an example of a layer structure of the air battery according to the present invention, which is a view schematically showing a section cut in the laminating direction. The air battery of the present invention is not limited to this example only.

Air battery 100 comprises air electrode 6, which has air electrode layer 2 and air electrode current collector 4, negative electrode 7, which has negative electrode active material layer 3 and negative electrode current collector 5, and electrolyte layer 1, which is sandwiched by the air electrode 6 and the negative electrode 7.

Hereinafter, the air electrode, negative electrode and electrolyte layer, which comprise the air battery of the present invention, and a separator and battery case which are suitably used in the air battery of the present invention, will be explained in detail.

The air electrode used in the present invention preferably comprises an air electrode layer, and in general, it further comprises an air electrode current collector and an air electrode lead connected to the air electrode current collector.

The air electrode layer used in the present invention comprises at least an electroconductive material. In addition, the air electrode layer can comprise at least one of a catalyst and a binder, as needed.

The electroconductive material used in the present invention is not particularly limited as long as it is electrically conductive. As the material, for example, there may be mentioned a carbonaceous material, a perovskite-type electroconductive material, a porous electroconductive polymer and a porous metal material. Especially, the carbonaceous material can be porous or non-porous. It is preferably porous in the present invention, so that it has a large specific surface area and offers many reaction sites. As the porous carbonaceous material, in particular, there may be mentioned mesoporous carbon, etc. As the non-porous carbonaceous material, in particular, there may be mentioned graphite, acetylene black, carbon black, carbon nanotube, carbon fiber, etc. The content of the electroconductive material in the air electrode layer is preferably 10 to 99% by mass, particularly preferably 50 to 95% by mass, when the mass of the whole air electrode layer is 100% by mass. This is because when the content of the electroconductive material is too small, the area of reaction sites is decreased, resulting in a possible decrease in battery capacity. On the contrary, when the content of the electroconductive material is too large, the content of the catalyst becomes relatively small, resulting in a possibility of poor catalyst performance.

As the catalyst for the air electrode used in the present invention, for example, there may be mentioned an oxygen-activating catalyst. Examples of the oxygen-activating catalyst include platinum group metals such as nickel, palladium and platinum; perovskite-type oxides comprising a transition metal such as cobalt, manganese or iron; inorganic compounds comprising a noble metal oxide such as ruthenium, iridium or palladium; metal coordinated organic compounds having a porphyrin structure or phthalocyanine structure; and manganese oxides. The content of the catalyst in the air electrode layer is not particularly limited. For example, when the mass of the whole air electrode layer is 100% by mass, the catalyst content is preferably 0 to 90% by mass, particularly preferably 1 to 90% by mass.

From the viewpoint of smooth electrode reaction, the catalyst can be supported by the above-described electroconductive material.

The air electrode layer is needed to contain at least the electroconductive material. However, it is more preferable that the air electrode layer further contains a binder for fixing the electroconductive material. As the binder, for example, there may be mentioned polyvinylidene fluoride (PVDF), polytetrafluoroethylene (PTFE) and rubber resins such as styrene-butadiene rubber. The content of the binder in the air electrode layer is not particularly limited. For example, it is preferably 1 to 40% by mass, particularly preferably 1 to 10% by mass, when the mass of the whole air electrode layer is 100% by mass.

The method for producing the air electrode layer can be produced by the following methods, for example: a method in which materials for the air electrode layer, including the electroconductive material, are mixed and roll-pressed; and a method in which a solvent is added to the materials to prepare a slurry and the slurry is applied onto the below-described air electrode current collector. However, the air electrode layer production method is not limited to these example methods. As the method for applying the slurry to the air electrode current collector, for example, there may be mentioned known methods such as a spray method, a screen printing method, a doctor blade method, a gravure printing method and a die coating method.

The thickness of the air electrode layer depends on the application of the air battery. However, the thickness is 2 to 500 μm for example, particularly preferably 5 to 300 μm.

The air electrode current collector used in the present invention functions to collect current from the air electrode layer. The material for the air electrode current collector is not particularly limited as long as it is electrically conductive. For example, there may be mentioned stainless-steel, nickel, aluminum, iron, titanium and carbon. As the form of the air electrode current collector, there may be mentioned a foil form, a plate form and a mesh (grid) form, for example. Of these, in the present invention, the air electrode current collector is preferably in a mesh form, from the viewpoint of excellent current collection efficiency. In this case, normally, the air electrode current collector in a mesh form is provided inside the air electrode layer. In addition, the air battery of the present invention can comprise a different air electrode current collector (such as a current collector in a foil form) that collects current collected by the air electrode current collector in a mesh form. Also in the present invention, the below-mentioned battery case can also function as the air electrode current collector.

The thickness of the air electrode current collector is 10 to 1,000 μm for example, particularly preferably 20 to 400 μm.

The negative electrode used in the present invention preferably comprises a negative electrode active material layer comprising a negative electrode active material. In general, it further comprises a negative electrode current collector and a negative electrode lead that is connected to the negative electrode current collector.

The negative electrode active material layer used in the present invention comprises a negative electrode active material comprising at least one selected from the group consisting of a metal material, an alloy material and a carbonaceous material. Concrete examples of metal and alloy materials that can be used in the negative electrode active material include alkali metals such as lithium, sodium and potassium; the Group 2 elements such as magnesium and calcium; the Group 13 elements such as aluminum; transition metals such as zinc and iron; and alloy materials and compounds comprising these metals.

Examples of lithium-containing alloys include a lithium-aluminum alloy, a lithium-tin alloy, a lithium-lead alloy and a lithium-silicon alloy. Examples of lithium-containing metal oxides include a lithium-titanium oxide. Examples of lithium-containing metal nitrides include a lithium-cobalt nitride, a lithium-iron nitride and a lithium-manganese nitride. Also, a solid electrolyte-coated lithium can be used for the negative electrode active material layer.

The negative electrode active material layer can comprise the negative electrode active material only, or it can comprise at least one of the electroconductive material and the binder, in addition to the negative electrode active material. For example, when the negative electrode active material is in the form of a foil, the negative electrode active material layer can be a negative electrode active material layer comprising the negative electrode active material only. When the negative electrode active material is in the form of powder, the negative electrode active material layer can be a negative electrode active material layer comprising the negative electrode active material and the binder. The type and content of the binder are the same as those described above.

The electroconductive material contained in the negative electrode active material layer is not limited as long as it is electrically conductive. As the material, for example, there may be mentioned a carbonaceous material, a perovskite-type electroconductive material, a porous electroconductive polymer and a porous metal material. The carbonaceous material can be porous or non-porous. As the porous carbonaceous material, in particular, there may be mentioned mesoporous carbon, etc. As the non-porous carbonaceous material, in particular, there may be mentioned graphite, acetylene black, carbon nanotube, carbon fiber, etc.

The materials for the negative electrode current collector used in the present invention, is not particularly limited as long as it is electrically conductive. For example, there may be mentioned copper, stainless-steel, nickel and carbon. Of these, SUS and Ni are preferably used for the negative electrode current collector. As the form of the negative electrode current collector, there may be mentioned a foil form, a plate form and a mesh (grid) form, for example. In the present invention, the below-mentioned battery case can also function as the negative electrode current collector.

The electrolyte layer used in the present invention is present between the air electrode and the negative electrode, preferably between the air electrode layer and the negative electrode active material layer, and it functions to exchange metal ions between the air electrode and the negative electrode (preferably between the air electrode layer and the negative electrode active material layer).

In the electrolyte layer, the above-described ionic liquid for air batteries according to the present invention and other liquid electrolytes can be used. They can be used alone or in combination of two or more kinds. When the present invention is a lithium-air battery, the above-described liquid electrolyte for lithium-air batteries according to the present invention, can be used.

Examples of other liquid electrolytes that can be used in the electrolyte layer include an aqueous liquid electrolyte and a non-aqueous liquid electrolyte.

It is preferable to select the type of the non-aqueous liquid electrolyte appropriately, depending on the type of metal ions to be conducted. For example, as the non-aqueous liquid electrolyte used in lithium-air batteries, a non-aqueous liquid electrolyte containing the above-described lithium salt and non-aqueous solvent is generally used.

It is preferable to select the type of the aqueous liquid electrolyte appropriately, depending on the type of metal ions to be conducted. For example, as the aqueous liquid electrolyte used in lithium-air batteries, one containing a lithium salt and water is generally used. As the lithium salt, there may be mentioned lithium salts such as LiOH, LiCl, LiNO₃ and CH₃CO₂Li.

In the air battery of the present invention, a separator can be present between the air electrode and the negative electrode. As the separator, for example, there may be mentioned porous films such as those made of polyethylene and polypropylene; and non-woven fabrics such as those made of resins including polypropylene, and those made of glass fibers.

These materials which can be used as the separator can be also used as a liquid electrolyte-supporting material by impregnating these materials with the above-described liquid electrolyte.

The air battery of the present invention generally comprises a battery case for housing the air electrode, the negative electrode, the electrolyte layer and so on. As the form of the battery case, in particular, there may be mentioned a coin form, a flat plate form, a cylinder form and a laminate form, for example. The battery case can be an open-to-the-atmosphere battery case or closed battery case. The open battery case is one that has a structure in which at least the air electrode layer can be sufficiently exposed to the air. On the other hand, when the battery case is a closed battery case, it is preferable that the closed battery case is equipped with gas (air) inlet and outlet tubes. In this case, it is preferable that the introduced/emitted gas has a high oxygen concentration, and it is more preferable that the introduced/emitted gas is dry air or pure oxygen. It is also preferable that the oxygen concentration is high at the time of discharge and low at the time of charge.

Inside the battery case, an oxygen permeation membrane and/or a water repellent membrane can be present, depending on the structure of the battery case.

### EXAMPLES

Hereinafter, the present invention will be further described in detail, with reference to examples and comparative examples. However, the present invention is not limited to these examples.

### 1. Preparation of Liquid Electrolyte for Lithium-Air Batteries

### Example 1

Lithium bis(trifluoromethanesulfonyl)amide (manufactured by Kishida Chemical Co., Ltd., and hereinafter may be referred to as LiTFSA) was weighed and mixed with triethylpentylphosphonium bis(trifluoromethanesulfonyl)amide having the structure represented by the following formula (4) (manufactured by Kanto Chemical Co., Inc., and hereinafter may be referred to as P2225TFSA) so that the concentration of the lithium bis(trifluoromethanesulfonyl)amide would be 0.58 mol/kg. The mixture was stirred so as to be uniform in composition, thereby preparing the liquid electrolyte for lithium-air batteries of Example 1.

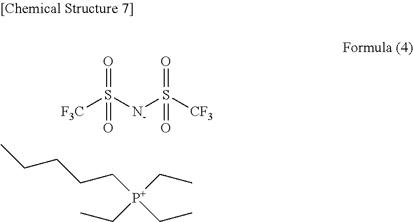

### Example 2

LiTFSA (manufactured by Kishida Chemical Co., Ltd.) was weighed and mixed with tris(dimethylamino)-n-butoxyphosphonium bis(trifluoromethanesulfonyl)amide having the structure represented by the following formula (5) (manufactured by Kanto Denka Kogyo Co., Ltd., and hereinafter may be referred to as TDMABPTFSA) so that the concentration of LiTFSA would be 0.58 mol/kg. The mixture was stirred so as to be uniform in composition, thereby preparing the liquid electrolyte for lithium-air batteries of Example 2.

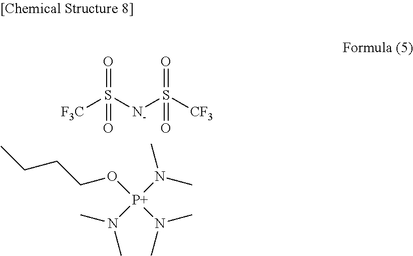

### Example 3

LiTFSA (manufactured by Kishida Chemical Co., Ltd.) was weighed and mixed with ethyltri(butylmethylamino)phosphonium bis(trifluoromethanesulfonyl)amide having the structure represented by the following formula (6) (manufactured by Kanto Denka Kogyo Co., Ltd., and hereinafter may be referred to as ETMBAPTFSA) so that the concentration of LiTFSA would be 0.58 mol/kg. The mixture was stirred so as to be uniform in composition, thereby preparing the liquid electrolyte for lithium-air batteries of Example 3.

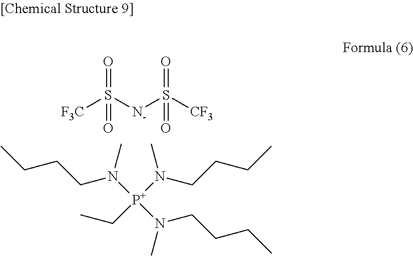

### Comparative Example 1

LiTFSA (manufactured by Kishida Chemical Co., Ltd.) was weighed and mixed with N,N-diethyl-N-methyl-N-(2-methoxyethyl)ammonium bis(trifluoromethanesulfonyl)amide having the structure represented by the following formula (7) (manufactured by Kanto Chemical Co., Inc., and hereinafter may be referred to as DEMETFSA) so that the concentration of LiTFSA would be 0.58 mol/kg. The mixture was stirred so as to be uniform in composition, thereby preparing the liquid electrolyte for lithium-air batteries of Comparative Example 1.

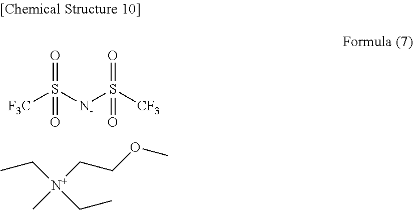

### 2. Chronoamperometry

Each of the liquid electrolytes for lithium-air batteries of Examples 1 to 3 and Comparative Example 1 was poured into a measurement cell. The components of the measurement cell are as follows:

Working electrode: Glassy carbon (φ 3 mm)

Reference electrode: Ag/Ag⁺

Counter electrode: Ni

First, the atmosphere in each measurement cell was replaced by argon gas for 30 minutes. Next, each measurement cell was placed in a constant temperature bath at 25° C. for 3 hours. Then, chronoamperometry was performed on each measurement cell. In particular, using potentiostat/galvanostat (manufactured by Solartron), for each liquid electrolyte for lithium-air batteries in each measurement cell, current change was measured during electrical potential was kept for 10 minutes at the below-mentioned oxygen reduction peak potential to measure oxygen reduction current value A₀ of each liquid electrolyte for lithium-air batteries under an argon atmosphere.

### <Oxygen Reduction Peak Potential>

Liquid electrolyte for lithium-air batteries of Example 1: −1.24 V (vs. Ag/Ag⁺)

Liquid electrolyte for lithium-air batteries of Example 2: −1.32 V (vs. Ag/Ag⁺)

Liquid electrolyte for lithium-air batteries of Example 3: −1.37 V (vs. Ag/Ag⁺)

Liquid electrolyte for lithium-air batteries of Comparative Example 1: −1.17 V (vs. Ag/Ag⁺)

Next, the atmosphere in each measurement cell was replaced by oxygen gas for 30 minutes. Then, each measurement cell was placed in a constant temperature bath at 25° C. for 3 hours. In the same condition as that of the argon atmosphere, chronoamperometry was performed to measure oxygen reduction current value A₁ of each liquid electrolyte for lithium air batteries under an oxygen atmosphere.

A value was obtained by deducting the oxygen reduction current value A₀ under the argon atmosphere (an inert atmosphere) from the oxygen reduction current value A₁ under the oxygen atmosphere. Hereinafter, the value will be treated as the oxygen reduction current value of each liquid electrolyte for lithium-air batteries.

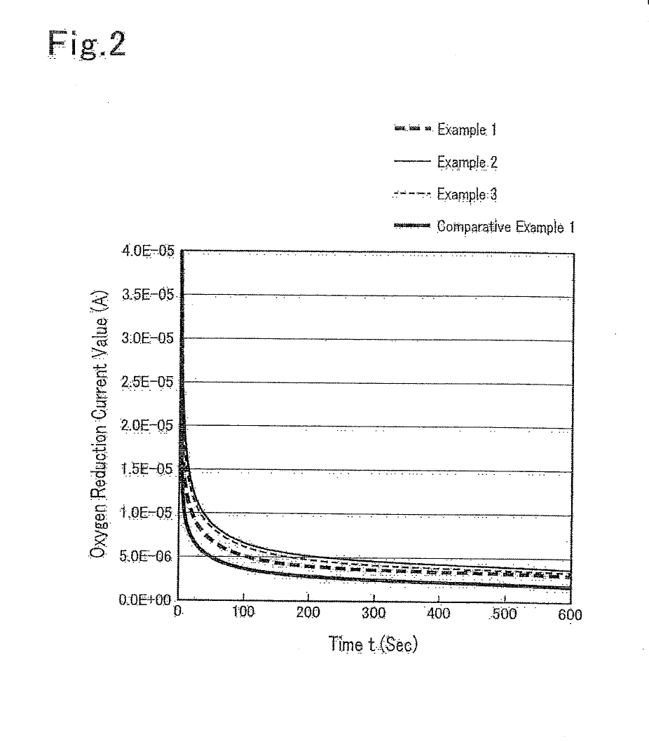

FIG. 2 is a graph comparing the time dependencies of oxygen reduction current values of liquid electrolytes for lithium-air batteries of Examples 1 to 3 and Comparative Example 1. FIG. 2 is a graph with the time (seconds) on the abscissa and the oxygen reduction current value (A) on the ordinate. In FIG. 2, a light, thick curve shows the data of Example 1; a dark, thin curve shows the data of Example 2; a light, thin curve shows the data of Example 3; and a dark, thick curve shows the data of Comparative Example 1.

FIG. 2 shows that the oxygen reduction current value of the liquid electrolyte for lithium-air batteries of Comparative Example 1, comprising the ammonium cation-containing DEMETFSA, is 1.77×10⁻⁶ A in 10 minutes (600 seconds). Meanwhile, the oxygen reduction current value of the liquid electrolyte for lithium-air batteries of Example 1, comprising the phosphonium cation-containing P2225TFSA, is 3.00×10⁻⁶ A in 10 minutes (600 seconds); the oxygen reduction current value of the liquid electrolyte for lithium-air batteries of Example 2, comprising the phosphonium cation-containing TDMABPTFSA, is 3.74×10⁻⁶ A in 10 minutes (600 seconds); and the oxygen reduction current value of the liquid electrolyte for lithium-air batteries of Example 3, comprising the phosphonium cation-containing ETMBAPTFSA, is 3.35×10⁻⁶ A in 10 minutes (600 seconds).

From these results, it is clear that each of the oxygen reduction current values of the phosphonium cation-containing liquid electrolytes for lithium-air batteries of Examples 1 to 3, is 1.7 times or more the oxygen reduction current value of the conventional, ammonium-containing liquid electrolyte for lithium-air batteries. Therefore, it is clear that the phosphonium cation-containing liquid electrolyte for lithium-air batteries according to the present invention, has better oxygen supply properties, compared to conventional, ammonium cation-containing liquid electrolyte for lithium-air batteries.

### 3. Measurement of Electrical Conductivity

The electrical conductivity of each of the liquid electrolytes for lithium-air batteries of Examples 1 to 3 and Comparative Example 1, was measured with an electrical conductivity meter (SevenMulti-A manufactured by METTLER TOLEDO) under an argon atmosphere at 25° C.

The electrical conductivity of the liquid electrolyte for lithium-air batteries of Comparative Example 1, comprising the ammonium cation-containing DEMETFSA, is 2.55 mS/cm. Meanwhile, the electrical conductivity of the liquid electrolyte for lithium-air batteries of Example 1, comprising the phosphonium cation-containing P2225TFSA, is 3.0 mS/cm; the electrical conductivity of the liquid electrolyte for lithium-air batteries of Example 2, comprising the phosphonium cation-containing TDMABPTFSA, is 0.9 mS/cm; and the electrical conductivity of the liquid electrolyte for lithium-air batteries of Example 3, comprising the phosphonium cation-containing ETMBAPTFSA, is 1.7 mS/cm.

From these results, it is clear that each of the electrical conductivities of the liquid electrolytes for lithium-air batteries of Examples 1 to 3 is similar to or less than the electrical conductivity of the liquid electrolyte for lithium-air batteries of Comparative Example 1. Therefore, the reason why both the power density and discharge capacity of the lithium-air battery increased as described below in the present invention, is considered to be because of the excellent oxygen supply properties of the liquid electrolyte for lithium-air batteries, rather than the ion conductivity of the same.

### 4. Production of Lithium-Air Battery

### Example 4

First, ketjen black (ECP600JD manufactured by Ketjen Black International; hereinafter it may be referred to as KB) and PTFE (manufactured by Daikin Industries, Ltd.) were prepared as an electroconductive material and a binder, respectively. The electroconductive material and the binder were mixed at a ratio of KB:PTFE=90% by mass:10% by mass. The mixture was roll-pressed, dried and then formed to produce an air electrode layer. A 100 mesh of SUS304 (manufactured by The Nilaco Corporation) was prepared as an air electrode current collector, and the air electrode layer was attached to one side of the SUS mesh to produce an air electrode.

As the negative electrode current collector, a SUS304 foil (manufactured by The Nilaco Corporation) was prepared. As the negative electrode active material layer, a lithium metal (manufactured by Honjo Metal Co., Ltd.) was attached to one side of the SUS foil to produce a negative electrode.

A polypropylene non-woven fabric (JH1004N) immersed with the liquid electrolyte for lithium-air batteries of Example 1 of 100 mL, was used as an electrolyte layer. The electrolyte layer was sandwiched by the air electrode and the negative electrode, preventing aeration, so that the components are stacked in the order of the negative electrode current collector, the lithium metal, the electrolyte layer, the air electrode layer and the air electrode current collector, from the bottom of the direction of Earth's gravitational force, thus producing a lithium-air battery of Example 4. These processes were all conducted in a glove box under a nitrogen atmosphere.

The lithium-air battery of Example 4 was placed inside an electrochemical cell. Pure oxygen (manufactured by Taiyo Nippon Sanso Corporation, purity 99.9%) was introduced into the lithium-air battery, through the SUS mesh used as the air electrode current collector.

### Example 5

Air and negative electrodes were prepared in the same manner as Example 4.

A polypropylene non-woven fabric (JH1004N) immersed with the liquid electrolyte for lithium-air batteries of Example 2 of 100 mL, was used as the electrolyte layer.

Then, in the same manner as Example 4, the lithium-air battery of Example 5 was produced, using the negative electrode, the electrolyte layer and the air electrode. Pure oxygen was introduced into the lithium-air battery of Example 5, in the same manner as the lithium-air battery of Example 4.

### Example 6

Air and negative electrodes were prepared in the same manner as Example 4.

A polypropylene non-woven fabric (JH1004N) immersed with the liquid electrolyte for lithium-air batteries of Example 3 of 100 mL, was used as the electrolyte layer.

Then, in the same manner as Example 4, the lithium-air battery of Example 6 was produced, using the negative electrode, the electrolyte layer and the air electrode. Pure oxygen was introduced into the lithium-air battery of Example 6, in the same manner as the lithium-air battery of Example 4.

### Comparative Example 2

Air and negative electrodes were prepared in the same manner as Example 4.

A polypropylene non-woven fabric (JH1004N) immersed with the liquid electrolyte for lithium-air batteries of Comparative Example 1 of 100 mL, was used as the electrolyte layer.

Then, in the same manner as Example 4, the lithium-air battery of Comparative Example 2 was produced, using the negative electrode, the electrolyte layer and the air electrode. Pure oxygen was introduced into the lithium-air battery of Comparative Example 2, in the same manner as the lithium-air battery of Example 4.

### 5. Discharge Test

After the lithium air batteries of Examples 4 to 6 and Comparative Example 2 was placed in a constant temperature bath at 60° C. for 3 hours, a discharge test was conducted thereon in the following condition to measure the discharge capacity.

Testing device: Secondary battery charge/discharge testing system (BTS2004HT manufactured by NAGANO & Co., Ltd.)

Electrical current density: 0.1 mA/cm²

Electrode area: 2.5 cm²

Temperature inside the battery: 60° C.

Atmospheric pressure inside the battery: 1 atm

Atmosphere: Pure oxygen

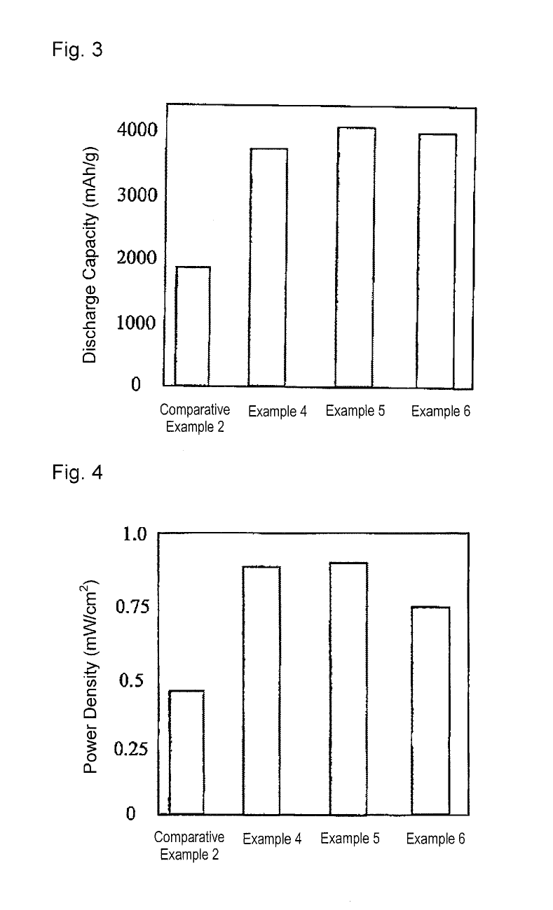

FIG. 3 is a bar graph comparing the discharge capacities of lithium-air batteries of Examples 4 to 6 and Comparative Example 2. FIG. 3 is a graph with the discharge capacity (mAh/g) on the ordinate.

FIG. 3 shows that the discharge capacity of the lithium-air battery of Comparative Example 2, comprising the ammonium cation-containing ionic liquid of Comparative Example 1, is 1,713 mAh/g. Meanwhile, the discharge capacity of the lithium-air battery of Example 4, comprising the phosphonium cation-containing ionic liquid of Example 1, is 3,658 mAh/g; the discharge capacity of the lithium-air battery of Example 5, comprising the phosphonium cation-containing ionic liquid of Example 2, is 4,015 mAh/g; and the discharge capacity of the lithium-air battery of Example 6, comprising the phosphonium cation-containing ionic liquid of Example 3, is 3,985 mAh/g.

From these results, it is clear that each of the discharge capacities of the lithium-air batteries of Examples 4 to 6, comprising the phosphonium cation-containing ionic liquid, is 2.1 times or more the discharge capacity of the conventional lithium air battery comprising the ammonium cation-containing ionic liquid.

### 6. I-V Test

After the lithium-air batteries of Examples 4 to 6 and Comparative Example 2 was placed in a constant temperature bath at 60° C. for 3 hours, the I-V test was conducted thereon in the following condition to measure the power density.

Charge/discharge I-V measurement system: Multi-channel Potentiostat/galvanostat VMP3 (manufactured by Bio-Logic SAS)

Current applied period: 30 minutes

Quiescent period: 0.1 seconds

Temperature inside the battery: 60° C.

Atmospheric pressure inside the battery: 1 atm

Atmosphere: Pure oxygen

FIG. 4 is a bar graph comparing the power densities of lithium-air batteries of Examples 4 to 6 and Comparative Example 2. FIG. 4 is a graph with the power density (mW/cm²) on the ordinate.

FIG. 4 shows that the power density of the lithium-air battery of Comparative Example 2, comprising the ammonium cation-containing ionic liquid of Comparative Example 1, is 0.48 mW/cm². Meanwhile, the power density of the lithium-air battery of Example 4, comprising the phosphonium cation-containing ionic liquid of Example 1, is 0.88 mW/cm²; the power density of the lithium-air battery of Example 5, comprising the phosphonium cation-containing ionic liquid of Example 2, is 0.89 mW/cm²; and the power density of the lithium-air battery of Example 6, comprising the phosphonium cation-containing ionic liquid of Example 3, is 0.75 mW/cm².

From these results, it is clear that each of the power densities of the lithium-air batteries of Examples 4 to 6, comprising the phosphonium cation-containing ionic liquid, is 1.6 times or more the power density of the conventional lithium air battery comprising the ammonium cation-containing ionic liquid.

### REFERENCE SIGNS LIST

1. Electrolyte layer
2. Air electrode layer
3. Negative electrode active material layer
4. Air electrode current collector
5. Negative electrode current collector
6. Air electrode
7. Negative electrode
100. Air battery

1. An ionic liquid for air batteries, comprising a cation and a counter anion thereof,
wherein the cation has a structure represented by the following general formulae (1), (2) or (3): 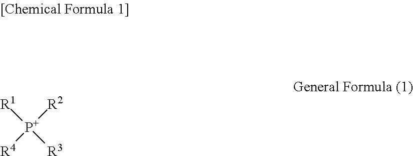
wherein R¹ to R⁴ are independent of each other, and R¹ to R⁴ are each selected from the group consisting of: an aliphatic hydrocarbon group having 1 to 8 carbon atoms; an aromatic hydrocarbon group having 6 to 10 carbon atoms; an amino group represented by —NR^{a}R^{b} in which R^{a} and R^{b} are groups independent of each other and R^{a} and R^{b} are each a hydrogen, an aliphatic hydrocarbon group having 1 to 8 carbon atoms or an aromatic hydrocarbon group having 6 to 10 carbon atoms; an alkoxy group represented by —OR^{c} in which R^{c} is an aliphatic hydrocarbon group having 1 to 8 carbon atoms; and an aryloxy group represented by —OR^{d} in which R^{d} is an aromatic hydrocarbon group having 6 to 10 carbon atoms; 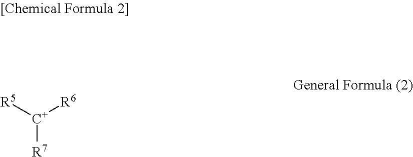
wherein R⁵ to R⁷ are independent of each other, and R⁵ to R⁷ are each selected from the group consisting of: an aliphatic hydrocarbon group having 1 to 8 carbon atoms; an aromatic hydrocarbon group having 6 to 10 carbon atoms; an amino group represented by —NR^{a}R^{b} in which R^{a} and R^{b} are groups independent of each other and R^{a} and R^{b} are each a hydrogen, an aliphatic hydrocarbon group having 1 to 8 carbon atoms or an aromatic hydrocarbon group having 6 to 10 carbon atoms; an alkoxy group represented by —OR^{c} in which R^{c} is an aliphatic hydrocarbon group having 1 to 8 carbon atoms; and an aryloxy group represented by —OR^{d} in which R^{d} is an aromatic hydrocarbon group having 6 to 10 carbon atoms; and 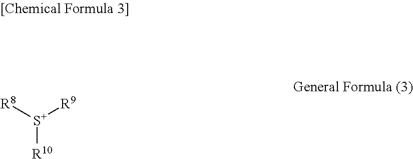
wherein R⁸ to R¹⁰ are independent of each other, and R⁸ to R¹⁰ are each selected from the group consisting of: an aliphatic hydrocarbon group having 1 to 8 carbon atoms; an aromatic hydrocarbon group having 6 to 10 carbon atoms; an amino group represented by —NR^{a}R^{b} in which R^{a} and R^{b} are groups independent of each other and R^{a} and R^{b} are each a hydrogen, an aliphatic hydrocarbon group having 1 to 8 carbon atoms or an aromatic hydrocarbon group having 6 to 10 carbon atoms; an alkoxy group represented by —OR^{c} in which R^{c} is an aliphatic hydrocarbon group having 1 to 8 carbon atoms; and an aryloxy group represented by —OR^{d} in which R^{d} is an aromatic hydrocarbon group having 6 to 10 carbon atoms.

2. The ionic liquid for air batteries according to claim 1,
wherein at least one of R¹ to R⁴ in the general formula (1), at least one of R⁵ to R⁷ in the general formula (2), or at least one of R⁸ to R¹⁰ in the general formula (3) is an amino group represented by —NR^{a}R^{b}, and
wherein R^{a} and R^{b} are groups independent of each other and R^{a} and R^{b} are each an aliphatic hydrocarbon group having 1 to 8 carbon atoms or an aromatic hydrocarbon group having 6 to 10 carbon atoms.

3. The ionic liquid for air batteries according to claim 1,
wherein at least one of R¹ to R⁴ in the general formula (1), at least one of R⁵ to R⁷ in the general formula (2) or at least one of R⁸ to R¹⁰ in the general formula (3) is an alkoxy group represented by —OR^{c} in which R^{c} is an aliphatic hydrocarbon group having 1 to 8 carbon atoms.

4. A liquid electrolyte for lithium air batteries, comprising a lithium salt and the ionic liquids defined by claim 1.

5. An air battery comprising an air electrode, a negative electrode and an electrolyte layer present between the air and negative electrodes,
wherein the electrolyte layer comprises the ionic liquids defined by claim 1.
